(19) United States
(12) Patent Application Publication
(10) Pub. No.: US 2009/0248522 A1
(43) Pub. Date: Oct. 1, 2009

(54) Method And Device For Advertisement Lease-Purchase And Switching Mechanism Of Advertisement Network

(76) Inventor: Chung-Ming Hu, Taipei City (TW)

Correspondence Address: LIN & ASSOCIATES INTELLECTUAL PROPERTY, INC., P.O. BOX 2339, SARATOGA, CA, 95070-0339, US

(21) Appl. No.: 12/408,676

(22) Filed: Mar. 21, 2009

(30) Foreign Application Priority Data
Mar. 25, 2008 (TW) 097110618

(51) Int. Cl. G06Q 30/00; G09G 3/30

(52) U.S. Cl. 705/14; 705/26; 345/76

(57) ABSTRACT

A method for advertisement lease-purchase and switching mechanism of advertisement network is provided. The method includes the steps of: users applying for memberships and/or logging in a bidding system; bidding in accordance with a selected area, time slot, or page; after winning a bid, uploading an advertisement file to an internet data center (IDC); verifying a file format of the uploaded advertisement file and/or converting the file format; and downloading the advertisement file to a multimedia apparatus. The present invention also provides a device for advertisement lease-purchase and switching mechanism of advertisement network. The device includes an internet data center (IDC, e.g., a machine room), a management platform, and one or more multimedia apparatus. The IDC includes a server, a bidding interface, and an uploading interface. The device can be connected to clients' PC ends for receiving data inputted by the clients for executing the advertisement network bidding operation.

### BACKGROUND OF THE INVENTION

1. Field of the Invention

The present invention relates generally to a method and a device for advertisement lease-purchase and switching mechanism of an advertisement network. The present invention employs functions of advertisement lease-purchase and online bidding, so as to realize the computerization, automation, transparency, and rationalization of the advertisement lease-purchase and switching mechanism of the advertisement network, thus further promoting the development of advertisement enterprises.

2. The Prior Arts

Nowadays, the current society is being commercially and industrially fast developed, in which promotion and marketing of products and services are typically the most important commercial activities for ordinary business entities. For achieving a sustainable operation and development, business entities often commit to spreading and selling their products or services. Typically, the spreading and selling of the products and services are often propelled by advertisements. Advertisement distributed by media often plays a critical role in letting the prospective customers to be aware of the features or advantages of the products or services, and approaches by which they can obtain the products or services. As such, in the current commercially and industrially developed society, the provision, lease-purchase, and distribution of advertisements have become a very important and influential service business, which is known as having revenue of operation up to tens of billions dollars which is even growing up.

Recently, the science and technology are being fast developed, and correspondingly the computer technology and network technology are also fast developed. However, the advertisement lease-purchase operations are still often handled in a conventional manual manner. Such advertisement lease-purchase operations involve the interactions between advertisement operators (e.g., TV stations or broadcasting stations), advertisement agencies, and advertisers (buyers of advertisement service).

Regarding current advertisement operations, an advertisement operator typically divides his advertisement time into different time slots for leasing to clients, respectively. Specifically, the advertisement operator may consign the advertisement time slots or pages to advertisement agencies or media purchasers for finding out prospective advertisers. This process usually consumes a lot of time and manpower cost. Taking television advertisement for example, advertisements allocated at different time slots usually have different values. However, it is rather difficult to make proper prices for the different time slots, respectively, in further view of the distinction between their values. Conventionally, the advertisement operator often simply assigns roughly estimated prices to the different time slots (or pages). These prices are then provided to the agencies, media purchasers, or directly to the advertiser. Unfortunately, the downstream clients may very probably disagree with the prices assigned to the time slots (or pages). Therefore, a lot of time and manpower must be consumed in negotiation with the downstream advertisement clients. Even after the negotiation, the finally determined prices are often affected by a variety of factors and are not exactly the market demanded prices. Further, such negotiations are conducted by human beings with less transparency, which increases the possibility of undertable deals.

### SUMMARY OF THE INVENTION

A primary objective of the present invention is to provide a method and a device for advertisement lease-purchase and switching mechanism of an advertisement network. The present invention employs functions of advertisement lease-purchase and online bidding, so as to realize the computerization, automation, transparency, and rationalization of the advertisement lease-purchase and switching mechanism of the advertisement network, thus further promoting the development of advertisement enterprises.

According to an aspect of the present invention, a method for advertisement lease-purchase and switching mechanism of an advertisement network is provided. The method includes the steps of: users applying for memberships and/or logging in a bidding system; bidding in accordance with a selected area, time slot, or page; after winning a bid, uploading an advertisement file to an internet data center (IDC); verifying a file format of the uploaded advertisement file and/or converting the file format; and downloading the advertisement file to a multimedia apparatus.

According to another aspect of the present invention, a device for advertisement lease-purchase and switching mechanism of an advertisement network is provided. The device includes an internet data center (IDC, e.g., a machine room), a management platform, and one or more multimedia apparatus. The IDC includes a server, a bidding interface, and an uploading interface. The device can be connected to clients' PC ends for receiving data inputted by the clients for executing the advertisement network bidding operation.

Further, electronic boards (e.g., digital signages) are currently highly demanded products. The principle of the present invention can also be further applied to the different kinds of flat panel displays (FPD) or electronic show windows attached to transparent shop windows (e.g., glass or acrylic shop windows) for executing an advertisement lease-purchase presentation. In such a way, a territorial media network can be configured for executing such advertisement lease-purchase presentations. Therefore, the present invention can be applied not only to those electronic boards attached to the transparent shop windows, but also to ordinary flat panel displays, such as television screens, PC end displays, liquid crystal displays (LCD), plasma display panels (PDP), electroluminescence (EL) display panels, and electronic show windows. Briefly, an aforesaid FPD or electronic show window can be taken as a media interface or platform. Further, electronic boards, television walls, or electronic show windows can be divided into different groups in accordance with the territorial characteristics (consuming habits or customs) of where they are distributed. In different areas, different advertisements and messages can be correspondingly distributed. Further, controlled by network far ends, media interfaces or platforms can be further divided into different sub-groups for assigning with different time slots. Furthermore, pages or screens can also be divided for stratifying specific advertisement requirement of the clients. In such a way, optimal economic value and lowest transaction cost can be achieved with respect to the different areas, time slots and pages. Moreover, the bidding process can be executed via a network and therefore can precisely determine the market value of the advertisement.

Accordingly, the present invention combines an online bidding platform with a media advertisement playing interface, so as to provide an advertiser with a convenience for selecting advertisement playing platforms of different areas, different pages, or different time slots. Therefore, the advertiser is then allowed to play the advertisement via a network data uploading and transmitting system. In such a way, cost and time consumed on the communication between the advertiser and the advertisement playing platform operator can be drastically saved, and the market price can be accurately determined in accordance with the market demand. Specifically, the advertiser can bid with other advertisers by applying for logging or directly logging in an advertisement bidding webpage, and then selecting the desired area, and/or time slot, and/or page. After winning a bid, the advertiser then uploads an advertising movie or a text file to an internet data center (IDC). The uploaded advertising movie or text file is then verified or converted for assuring that a format thereof can be played by the advertisement playing platform. Then, the advertising move or text file is downloaded to multimedia apparatuses (e.g., PC, industrial computers, FPD) and is then played in designated area, time slot, and on designated advertisement playing platform. The advertisement playing platform can be any medium interface which can be openly played for information distribution, such as a digital signage, a television wall, or an electronic show window. Further, by such an advertisement bidding system, bidders are allowed not only bidding for specific area and/or time slot and/or page, but also bidding with respect to a large scale advertisement operation (e.g., once bidding for one or more advertisement opportunities, each including territorial, time slot, and page factors at the same time). Therefore, the advertiser is allowed to advertising in designated time slot and in different areas at the same time via a network connection and by a far end control.

In fact, in accordance with the advertisement bidding system of the present invention, the advertiser is allowed for selectively making advertisement in different areas, time slots and pages as desired according to the budget and advertisement target thereof. In the process of selecting the optimal advertisement platform, the risk of unreasonable quotation quoted by the advertisement operator or agencies can be avoided, so that the advertiser is more likely to obtain an expected advertising opportunity with a price most approximate to the market price. In such a mechanism, the advertising price is determined by the bidders. As such, there is less uncertainty caused by repetitive bargaining between the parties. Meanwhile, software or hardware for playing the advertisement may be further introduced for amplifying the advertising effect of the advertisement. For example, besides the conventional broadcasting or television media, the popularization of digital signages provides an alternative selection of advertisement playing interface. The digital signages can be provided in indoor, outdoor, or semi-outdoor environment, so as to provide a more instant and more diversified information transmission. Further, by selecting the areas, time slots, and page partitioning, the advertiser is allowed to adaptively obtaining a selected advertising opportunity. Therefore, even those advertisers having insufficient budgets can also bid for areas, time slots or pages which are less hot. Or otherwise, according to the difference between different industries, those areas or time slots which are generally believed as more popular may be not desired by a specific advertiser. Therefore, the advertiser may obtain his desired advertising opportunity with a lower bidding price. For example, a vintner may make advertisement for selling wine in a deep night time slot in a night club area with a relative low price. However, of course, an advertiser having enough funds can also select to playing his advertisement with a large amount of digital signages by bidding in batches, so as to strongly promote his products.

The digital signage type playing hardware can be flat panel displays, such as television screens, PC end displays, liquid crystal displays (LCD), plasma display panels (PDP), electroluminescence (EL) display panels, electronic show windows, and tiled flat displays. Specifically, when an electronic show window is used as an advertisement playing interface, the advertisement can be transferred to the viewers at close quarters. The electronic show window is configured with a single or tiled flat display attached to a glass or acrylic transparent medium. The medium for example can be supported by a fixed or movable supporter (e.g., a glass shop window, an aluminum door or window, a rack or a screen having a slide track). When a plurality of such show windows are connected in series for playing the advertisement, a more attractive effect can be achieved.

As such, according to the bidding system of a large scale digital signage advertising operation, the advertiser is not only capable of obtaining the desired advertising opportunity with a price which is most approximate to the market price, but also capable of presenting exquisite and changeable images so as to attract attention of many prospective customers in a short time.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a flow chart illustrating a method for advertisement lease-purchase and switching mechanism of an advertisement network according to an embodiment of the present invention;

FIG. 2 is a schematic diagram illustrating a device for advertisement lease-purchase and switching mechanism of an advertisement network according to an embodiment of the present invention;

FIG. 3 is a schematic diagram illustrating partition areas, time slots, and pages of an electronic board according to an embodiment of the present invention;

FIG. 4 illustrates an embodiment of the present invention, in which a tiled digital signage or an electronic show window is partitioned;

FIG. 5 illustrates an embodiment of the present invention, in which a tiled digital signage is partitioned for displaying a ball game at a center of the digital signage and displaying advertisement at a periphery of the digital signage; and

FIG. 6 is a schematic diagram illustrating a structure of an advertising network according to an embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

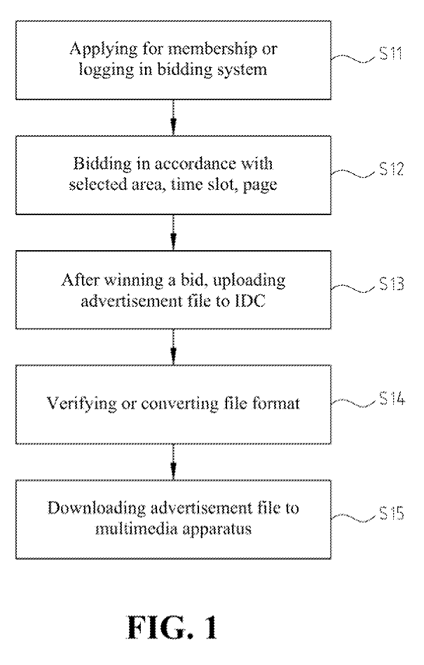

FIG. 1 is a flow chart illustrating a method for advertisement lease-purchase and switching mechanism of an advertisement network according to an embodiment of the present invention. Referring to FIG. 1, the method includes the following steps. First, at step S11, users apply for a membership and/or log in a bidding system. Then, at step S12, a bidding process is executed in accordance with areas, time slots, and pages selected by the users. At step S13, when one of the users wins a bid, the user uploads an advertisement file to an internet data center (IDC). Then, at step S14, a format of the uploaded advertisement file is verified or converted. Finally, at step S15, the advertisement file of the bid winner is downloaded to a designated multimedia apparatus for playing.

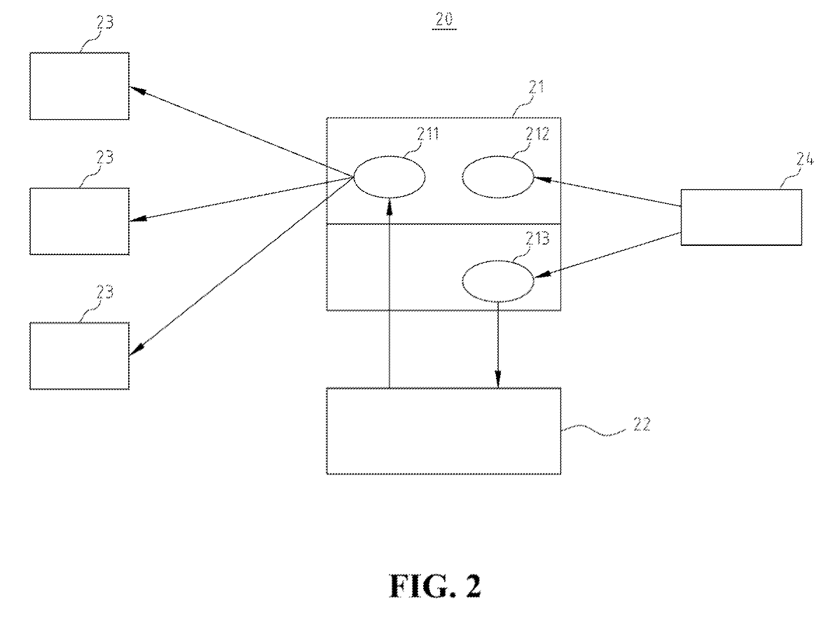

FIG. 2 is a schematic diagram illustrating a device 20 for advertisement lease-purchase and switching mechanism of an advertisement network according to an embodiment of the present invention. Referring to FIG. 2, the device 20 includes an IDC (i.e., a machine room) 21, a management platform 22, and one or more multimedia apparatus 23. The IDC 21 includes a server 211, a bidding interface 212, and an uploading interface 213. The server 211 is adapted for storing data and advertisement files of corresponding users. The management platform 22 is adapted for verifying the content of the format of the advertisement files. The device 20 is further connected to a client's PC end 24, for allowing the client to input related advertisement data.

Two preferred embodiments are to be given below for further illustrating the present invention in more details.

### First Preferred Embodiment

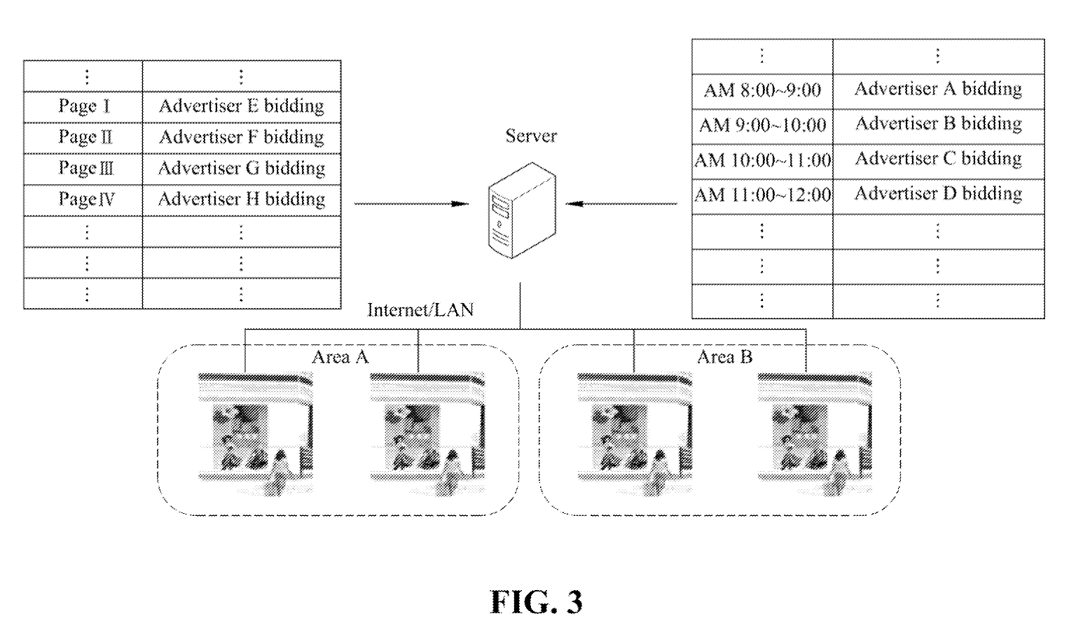

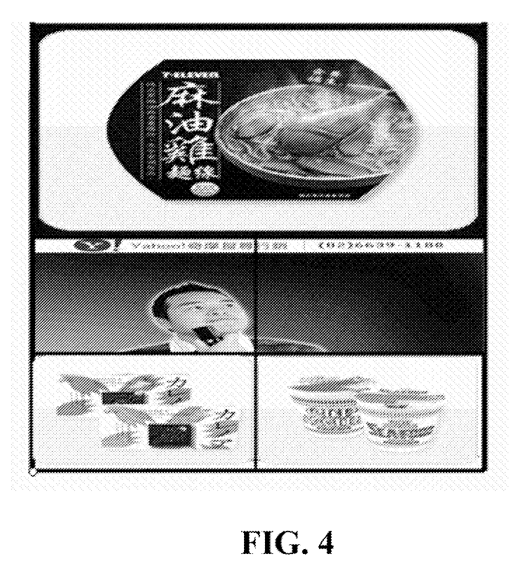

The present invention provides an advertisement bidding model. In accordance with the advertisement bidding model, an online bidding system is set up in advance. Any advertiser having the will of making advertisement may select to apply for membership of the bidding system. When an advertiser enters the bidding webpage, he can bid for desired advertisement area, time slot or page, as shown in FIGS. 1 and 3. If the advertiser wins a bid, he uploads an advertisement file, e.g., a movie or a text file, to a server of an IDC. The format of the uploaded advertisement file is verified or converted for complying with a certain requirement. Once verified or converted to be compliance with the certain requirement, the advertisement file is then downloaded by the server of the IDC to multimedia apparatuses of designated areas for playing. As shown in FIG. 4, an advertisement page or screen of a display apparatus can be used for displaying a full page advertisement or partitioned in a plurality of parts for displaying a plurality of advertisements at the same time. The portioning of the advertisement page or screen can be conducted in different areas at the same time or respectively by executing a far end control operation. The display apparatus for example can be a flat panel display, a digital signage, or an electronic show window. With the connection of the display apparatus, and in accordance with the partitioning of the areas, time slots, and pages, as well as the setting of the far end, the advertiser is very likely to obtain desired advertising opportunity which is most suitable for his products with a price most approximate to the market price.

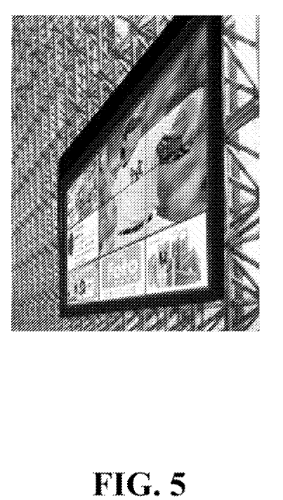

The partitioning of the page or screen of the FPD provides platforms for different advertisers for making advertisement. A full page or screen can be used for displaying advertisement. The full page or screen can also be partitioned into a plurality of parts for playing ball game, concert, and related images of the advertisement for attracting more fans of the ball game or concert to view the advertisement, thus getting acknowledgment of the advertised product. For example, in a page of broadcasting a base ball game, a part of the page may be partitioned for advertising related products as shown in FIG. 5.

Further, the advertiser can also select different areas or locations for playing the advertisement in a same time slot for promoting the familiarity and acceptance of the viewers to the advertised products. For example, advertisement for selling mobile phones or MP3 can be played at Hsimending Taipei in the afternoon time slot and the evening time slot mainly targeting toward the youngsters. Promotion advertisement can be made in wedding dress street or hotels during the time slot of the lunar New Year or before June. The advertiser can determine the object for bidding for by himself For example even though a breakfast franchisee or a convenience store may be not restricted by a certain budget, it still can bid for an area or time slot which is not so hot with a relative low price by saving the cost of negotiation with the advertisement agency and the media purchaser. The market price is transparently obtained, and therefore the risk of buying with an unreasonable high price can be avoided.

Briefly, the present invention provides a concept of online bidding for a digital signage advertisement, in which the users are allowed to determine the prices by themselves, so as to drastically saving the transaction cost and risk. Meanwhile, the bidding information can be collected and categorized, and thus used as reference for further marketing analysis (e.g., area, time slot, and industrial species, relevance between product features, and preference analysis). Most importantly, the present invention can employ a large scale tiled digital signage or electronic show window as a playing platform, so that the large area display can instantly capture attention of viewers, thus improving the advertising effect. Furthermore, the utilizing efficiency of the digital signage can be improved by partitioning the screen or page of the display in different ways.

For example, in order to attract viewers' attention, a part of the screen can be used for broadcasting a ball game or a TV program, and the rest part of the screen is used for playing the advertisement of the advertiser. Further, similar stores are often gathered in a specific region for attracting more customers to visit, e.g., furniture street, or wedding dress street. Similarly, digital signages distributed in a certain region also attract the similar stores to making advertisement together. In such a way, a prospective customer may be provided with a large amount of information within a short time, and is likely to be excited by the visional shock provided by the advertisement. The prospective customer is thus very likely to be impressed, or even triggered to go shopping the advertised product at once.

### Second Preferred Embodiment

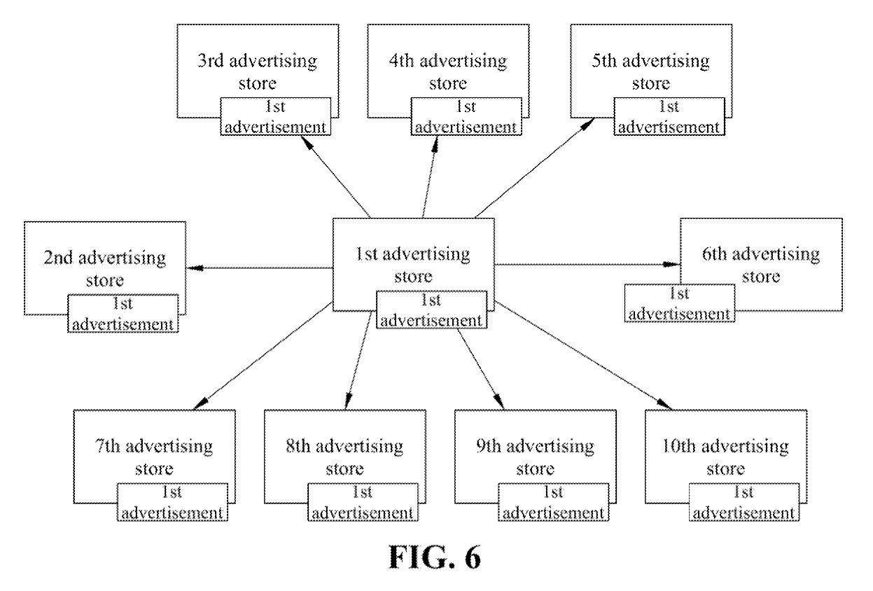

In order to develop an integrate advertising platform, the present invention further employs an advertisement exchanging model for attracting ordinary channels and stores to set up electronic show windows, and thus configuring a united advertisement network. Specifically, because of the amplified influence of the united advertisement network, the stores setting up electronic show windows can attract more prospective customers to visit. For example, supposing that there are ten stores join the united advertisement network, each sets up an electronic advertisement board. Each of the ten stores must provide a certain time slot or a certain page for playing advertisements of other stores. Correspondingly, the other nine stores also provide certain time slots or pages for playing the advertisement of this store. As such, each store can play advertisement not only in its own store, but also in other nine stores. In such a way, the store is equivalent to have nine virtual stores for attracting prospective customers to visit the real store, thus raising the revenue thereof, as shown in FIG. 6.

Moreover, after deducting the time shared by the stores within the united advertisement network, the owner of the advertising platform of the united advertisement network may lease or sell the rest time slots or pages to earn money. And the previously mentioned bid winner can play his advertisement in his time slot and page through the advertising network via a far end control mechanism.

Meanwhile, it should be noted that when the electronic show windows are constructed in a large scale, (e.g., setting up over a whole street), a better advertising can be achieved. In this manner, ordinary channels and stores can be attracted for agreeing to construct the electronic show windows, thus configuring a united electronic aisle or an advertisement ally. Such a specific giant advertising platform is more likely to attract attention of viewers.

Further, it should be noted that as discussed above, the present invention is exemplified with a tiled digital signage or a digital signage attached to a glass shop window for convenience of illustration. However, the present invention should not be construed as being restricted as such. Any commercialized electronic board such as television screen, PC terminal screen, liquid crystal displays (LCD), plasma display panels (PDP), electroluminescence (EL) display panels, and electronic show windows, can be used in accordance with the present invention.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A method for advertisement lease-purchase and switching mechanism of an advertisement network, comprising:
users applying for memberships and/or logging in a bidding system;
conducting a bidding process in accordance with areas, time slots, or pages selected by the users;
after winning a bid, one of the users uploading an advertisement file to an internet data center (IDC);
verifying a file format of the uploaded advertisement file and/or converting the file format into an acceptable file format; and
downloading the advertisement file to a multimedia apparatus for playing.

2. The method according to claim 1, wherein the multimedia apparatus is a PC, an industrial computer, or a flat panel display (FPD).

3. The method according to claim 2, wherein the FPD is a television screen, a PC terminal screen, a liquid crystal display (LCD) panel, a plasma display panel (PDP), an electroluminescence (EL) display panel, an electronic show window, a tiled flat display, or a flat display attached to a transparent shop window.

4. A device for advertisement lease-purchase and switching mechanism of an advertisement network, comprising:
an internet data center (IDC), comprising:
a server, for storing user related data and advertisement files of advertisers;
a bidding interface; and
an uploading interface;
a management platform, for verifying content and formats of the advertisement files; and
one or more multimedia apparatus, for playing the advertisements.

5. The device according to claim 4, wherein the multimedia apparatus is a PC, an industrial computer, or a flat panel display (FPD).

6. The device according to claim 5, wherein the FPD is a television screen, a PC terminal screen, a liquid crystal display (LCD) panel, a plasma display panel (PDP), an electroluminescence (EL) display panel, an electronic show window, a tiled flat display, or a flat display attached to a transparent shop window.

7. The device according to claim 4, wherein the IDC is connected to a client's PC end via a local area network (LAN), a wide area network (WAN), or an internet for receiving data inputted by the client, so as to conduct an advertisement bidding operation.

8. The device according to claim 6, wherein a screen frame of the FPD can be further partitioned into a plurality of sub-frames, for simultaneously displaying homogenous advertisement images or heterogeneous advertisement images.

9. The device according to claim 4, wherein the advertisement network is a united advertisement network configured by a plurality of advertisement operators in a manner of advertisement exchanging, wherein advertisement of each of the advertisement operators can be displayed in areas of the other advertisement operators.

10. The device according to claim 9, wherein an advertiser outside the advertisement network can play the advertisement thereof in a designated time slot or designated page with electronic advertisement boards in different areas at the same time
